(19) United States
(12) Patent Application Publication
(10) Pub. No.: US 2013/0214923 A1
(43) Pub. Date: Aug. 22, 2013

(54) Immobility Monitoring System

(71) Applicant: Barry Sheridan, Cooroy (AU)

(72) Inventor: Barry Sheridan, Cooroy (AU)

(73) Assignee: Seniors Wellbeing Pty Ltd, Cooroy (AU)

(21) Appl. No.: 13/824,871

(22) PCT Filed: Jun. 10, 2011
(86) PCT No.: PCT/AU2011/000719

§ 371 Date: Mar. 18, 2013

(30) Foreign Application Priority Data
Nov. 5, 2010 (AU) AU2010904925

(51) Int. Cl. G08B 21/04

(52) U.S. Cl. CPC G08B 21/043
USPC 340/521

(57) ABSTRACT

The invention relates to a system for monitoring inactivity or immobility of a person. The invention further relates to monitoring other situations where differing periods of time will need to be accurately monitored over days and or weeks.

### FIELD OF THE INVENTION

The invention relates to a system and method for monitoring inactivity or immobility of a person.

### BACKGROUND OF THE INVENTION

Providing reliable health care solutions is important both for patients, their families and their careers. As people age, they often become less mobile and less capable of caring for themselves. These people none the less wish to continue to remain independent and continue to live in their own homes for as long as they possibly can.

As these independent seniors age the responsibility for their care gradually passes to careers, friends and families. The types of vulnerable people requiring support generally fall into two groups; those who will eventually require constant attention and those who may require minimal supervision or assistance occasionally.

This invention is focused on the latter group, particularly but not exclusively individuals who are living alone. One of the greatest fears many in this group face are unrecoverable falls, or medical collapse. For many the possibility of lying undiscovered for many hours or even days and possible death are very real.

This invention has been designed to monitor for these events and automatically summon assistance.

A number of monitoring devices are available which can detect the activity of a person which is programmed to alert a contact person in case of prolonged inactivity, suggesting an emergency situation may have occurred. Such devices include monitoring sensors which record the movement of a person around their living area.

However, none of the devices allow monitoring of immobility of a person based on the ability of a device to be programmed by the user, with individuality differing immobility periods for every hour of every day and every day of the week.

It is an object of the invention to provide a reliable and effective system to detect immobility of a person.

### SUMMARY OF THE INVENTION

The present invention provides a system for monitoring the immobility of a person comprising one or a series of sensors or monitors and one or a series of programmable timers wherein the timers may be programmed from minute to minute or day to day.

Preferably, the system functions as an intruder alarm.

Preferably, the sensors/monitors are programmed to record daily activities of a person to produce the data obtained from the record, which is used to formulate a behavioral pattern report for the individual person.

Preferably, the program resets each time a movement activity is detected and recorded.

Preferably, the program records an emergency each time a daily recorded activity has not been activated.

Preferably, contact personnel is alerted as a result of the depressing of a remote emergency button in the event of an emergency.

Preferably, the contact personnel is/are alerted as a result of a panic/emergency button depression.

Preferably, the device monitors and calls for assistance if the ambient temperature reaches and records below or above the pre set parameters.

Preferably, the system further comprises a battery standby system installed to provide full operational capabilities for up to 12 hours, independent of any external power source.

In another aspect, the present invention provides a system for monitoring the immobility of a person comprising an immobility sensor, an immobility detection device, mobility activity indicators, mobility notifier, a controller unit and compatible software and hardware.

Preferably, the system further comprises one or a series of programmable timers.

Preferably, the timers may be programmed from minute to minute or day to day.

In another aspect, the present invention provides a method of monitoring the immobility of a person comprising a system according to the invention.

Preferably, the system or method according to the invention further comprises an emergency alert button.

Preferably, the button is worn by the user or placed near the user.

Preferably, the alarm is activated by two phases, Stage 1 and Stage 2.

Preferably, a predetermined period of inactivity is detected by the Immobility sensor thereby activating alarm Stage 1.

Preferably, alarm Stage 2 is activated if the user fails to intervene or respond to alarm stage 1.

Preferably, if the user fails to intervene or respond to Stage 1 alarm, and the Stage 2 alarm is activated, an automatic emergency alert message is sent to an emergency contact or contacts.

Preferably, the sensors or monitors are programmed to record all daily activities of all persons in the home, to produce activity reports.

Preferably, data from the daily activity report is used to formulate a behavioral pattern for the individual person/user.

Preferably, the activity report can be used to generate an actual and average week report in the life of the user.

Preferably, the activity report can be used to generate an optimum immobility default setting report for the Immobility Sensor for each day of a week.

In another aspect, the invention provides a method of monitoring the immobility of a person comprising:
activating a sensor which detects a period of activity;
detecting and recording a period of activity;
activating a stage 1 alarm at the end of an allotted pre-programmed inactivity period;
activating a stage 2 alarm if no response is received from the person during stage 1 alarm; and
sending an emergency message to a nominated contact(s).

Preferably, the Stage 1 alarm is activated upon detection of a predetermined period of inactivity.

Preferably, the Stage 2 alarm is activated if the user fails to intervene or respond to the stage 1 alarm.

Preferably, if the user fails to intervene or respond to Stage 1 alarm, and the Stage 2 alarm is activated, an automatic emergency alert message is sent to an emergency contact or contacts.

Preferably, the invention provides a method for use of the system according to the invention.

### BRIEF DESCRIPTION OF THE DRAWINGS

FIG. 1 illustrates an example of the recording of a Schedule as an embodiment of the present invention.

### DETAILED DESCRIPTION OF THE INVENTION

The present invention provides a device or system for monitoring the immobility of a person, particularly but not exclusively an individual who is living alone, comprising one or a series of sensors and a series of programmable timers wherein the timers may be programmed from second to second, minute to minute and day to day.

This invention has been designed to provide a degree of reassurance by monitoring the movement of the individual, and providing a call for assistance if the individual fails to remain active throughout their home.

An additional optional feature of this invention is its ability to monitor the ambient temperature in the home of the user and summon assistance if the environment is too hot or too cold for the occupant. This invention is designed to automatically summon assistance if extreme changes in temperature are detected.

In another embodiment, the invention provides the device further comprising a battery standby system installed to provide full operational capabilities for up to 12 hours, independent of any external power source. This feature is a unique feature in as much as the system does not need to send its information to an external computer or processing device for analysis, in order to summon assistance in an emergency.

In another embodiment, the invention provides the device further comprising a storage area within the device to record and store many days and weeks of all activity/alarm histories. Where upon if the device detects the presence of a removable memory storage device, the Immobility Sensor system will automatically download the contents of this activity recorded data to the removable memory device.

Thus, the present invention provides a system for monitoring the immobility of a person comprising of one or a series of sensors and one or a series of programmable timers wherein the timers may be programmed from minute to minute and day to day. If the user of the device fails to be detected moving around their home, the device will enter alarm modes 1 and 2 and summon help for the user.

Preferably in alarm state 1, the device will ask the user to indicate that they are well before it calls out for assistance.

Preferably, the device functions as an intruder alarm.

Preferably, the device functions as a fire detection alarm.

Preferably, the device functions as an extreme ambient temperature alarm

Preferably, the device functions as a panic/emergency button alarm

Preferably, the device functions as an immobility detection alarm

Preferably, the device will detect movement and ask the user to return the device to immobility, detection mode when the owner returns to their home.

Preferably, the device records all movements and system alarm activations.

Preferably, the sensors/monitors are programmed to record all daily activities of all persons in the home to produce activity reports. These reports will contain many days or weeks of activities.

Preferably, the data from the daily activity report is used to formulate a behavioral pattern for the individual person/user. This report can be exported to nominated careers. This report will be used to display and alert if any unusual patterns of behavior are evident.

Preferably the activity report can be used to generate an actual or average week report in the life of the user.

Preferably the activity report can be used to generate an optimum immobility default setting report for the Immobility Sensor for each day of a week. This report will aid in establishing and setting up the optimum periods to alarm tables for the new user.

Preferably, the hours/minutes will reset each time a movement activity is detected.

Preferably, the program records an emergency each time a daily recorded activity period reaches zero.

Preferably, contact personnel are alerted as a result of an immobility emergency.

Preferably contact personnel is/are alerted as a result of a panic/emergency button depression.

Preferably, the device monitors and calls for assistance if the ambient temperature reaches and records below or above the pre set parameters.

Preferably, the device further comprises a battery standby system installed to provide operational capabilities for up to 12 hours, independent of any external power source.

Preferably, the device monitors and alerts the user if there is a loss of power to the device.

Preferably, the device monitors and alerts the user if there is a failure of the telephone line.

Preferably the device will operate with 240v power supply.

Preferably the device will operate with 110v power supply

Preferable the device will operate with 12v power supply.

Preferably the device will continue to fully function while on battery backup.

Preferably the device will operate when hard wired to a PSDN line.

Preferably the device will operate when connected to a mobile GSM or similar network.

Preferably the device will operate when connected to the internet.

Preferably the device will operate when connected to a Wi-Fi connection.

### What Immobility Monitor Does

The Immobility Monitoring system is an electronic device designed to alert remote individuals, by using the landline or mobile telephone communications network or the internet communication system or a hard wire connection in the event that an individual living in their premises has failed to remain mobile during normal preprogrammed activity periods.

The device is supplied as a plug and play device with a factory default ready to operate setting.

The main control system can be programmed and changes effected to the following:
inactivity time periods, messages, contact details and ambient temperature settings and amended by the user or their representative by direct interface with the main Immobility Sensor device.

The user of the device is able to set and amend each alarm period on the device.

The user is able to record and amend up to 10 audio messages on the device.

To assist in setting the device up initially, the device is capable of capturing and recording normal mobility activities for days or weeks of the new user,. From this test captured data it is possible to analyze the data and configure the unit to the exact requirements of the individual user.

This invention can be programmed to monitor individual events ranging from one second through to a maximum of 72 hours for each hour of the day. It is also possible to record different individual events for every hour of every day of the week.

The device is supplied with a factory set activity routine, which will allow the device to be supplied as a plug and play device.

When the Monitoring system is activated, its prime purpose is to count down the seconds, minutes and or hours of the current monitoring immobility period, and to reach zero, at which time it will go into alarm mode one and two and summon assistance.

The system is only stopped reaching zero by receiving an activity detection signal, as a result of the detection of movement. This movement detection will cause the immobility monitoring device to instruct the on board countdown sequence to stop, and to restart a new hours and minutes countdown period again.

Each countdown activation period can vary, depending upon the hour of day and the day of the week it is activated. This reset/restart trigger is activated each time any of the sensors located in the home detect movement of the occupier in the premises.

The Immobility Sensor device will capture and store all daily activities of a person. The data obtained from the immobility monitor can be viewed on the device display or can be downloaded to a mobile device. This information can be used to analyze the behavioral pattern for the individual, to allow assessment of their overall daily weekly activities pattern.

With this type of monitoring it is necessary to disable the device when the user leaves home. The danger is that they will forget to rearm the device when they return. This invention is unique because it will detect their return, and remind them with an audible alert, and instruct them to return the unit to active mode. If they fail to obey or understand this instruction, help will be automatically called.

When the person leaves the premises, they will turn their immobility sensor to away mode. When the immobility sensor is in the away mode the device may then be used as a security or intruder alarm device system.

If when the owner returns home they do not return the monitor to Home mode, the device will automatically ask the owner to return the device to home mode.

If whilst in away mode activity is detected in the home and the device is not returned to home mode within 60 seconds, the unit will automatically access a dedicated sub routine to transmit an intruder detection signal to the assigned contacts programmed in the system.

In particular, The Immobility Monitoring alarm system is an electronic device, with software that is designed to detect when a person displays a prolonged or pre-determined or pre-programmed period of inactivity. The device comprises:
an Immobility Sensor, i.e., the Main Control unit;
an immobility detection device, i.e., a passive infrared motion detector;
mobility activity indicators, i.e., mechanical or radio circuit contacts to report circuit open/close changes;
emergency medical alarm pendant/button i.e., a depress button device to summon assistance;
mobility notifier, i.e., device worn on the person of the user to report any changes; a controller unit and
compatible software and hardware to operate the system.

The device will enter an alarm state and communicate that inactivity event to an external resources and request immediate assistance after the inactivity period has been exceeded.

Inactivity Periods

Each hour of a day can be programmed with multiple and varying inactivity alarm time periods within any 24 hour time period.

Each alarm time period can be varied from 1 second of inactivity between alarm events, to multiple hours, minutes and or seconds between alarm events.

Each day of the week, and or each day of each month can be programmed with differing hours and or minutes to alarm periods.

System Activation

The immobility Sensor will activate when a pre-programmed period of time has elapsed. This pre-programmed period of time represents an unacceptable period of immobility and will initiate alarm state/stage 1.

When the user activates a manual emergency alarm activation trigger, Alarm state/stage 2 will operate to immediately summon assistance.

System Start-up

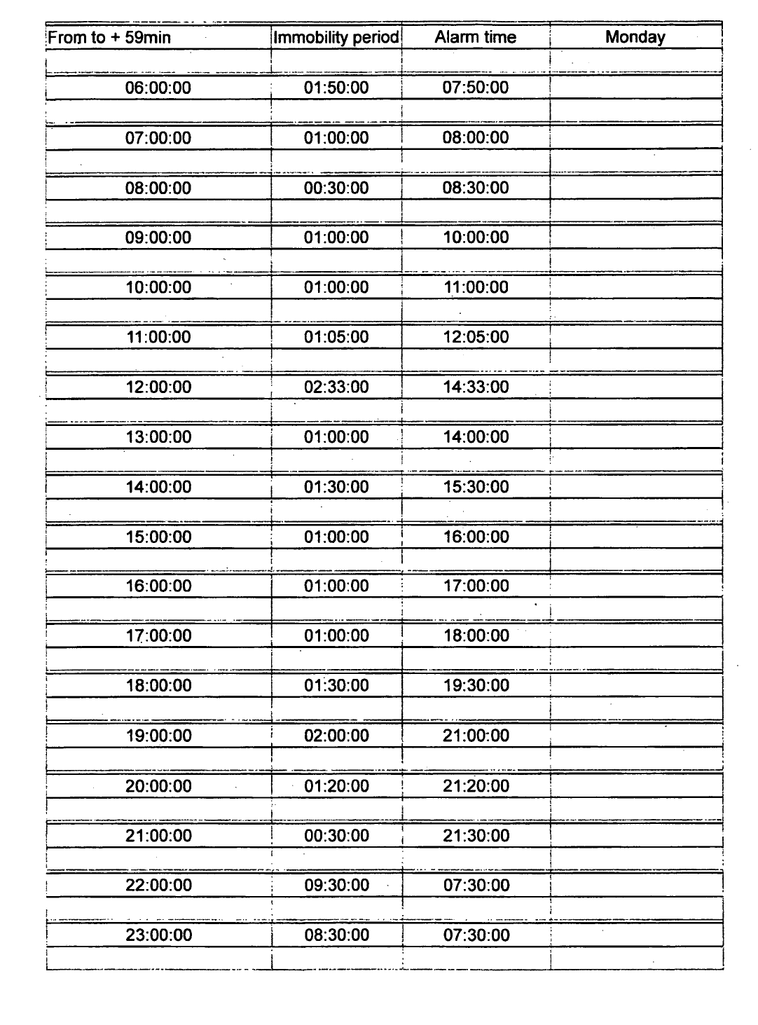

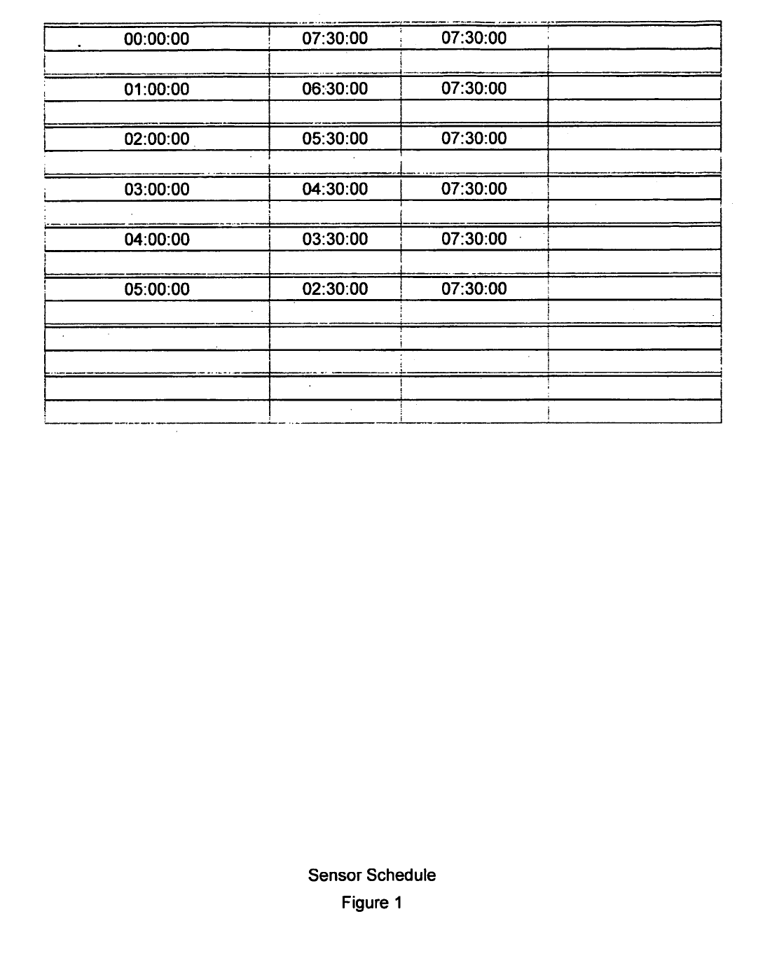

When switched on, the Immobility Sensor alarm system will start the hours/minutes to next alarm. The hours/minutes to next alarm period will be determined from the time and date of system activation table programmed in to the device. (See example FIG. 1).

System Reset/Activity Detection

The active hours/minutes to next alarm state will be stopped when activity is detected. Consequently, new hours/minutes to next alarm period will start. The new hours/minutes to alarm period will be determined from the time and date of system reset table programmed in to the device. (See example FIG. 1).

Mobility Detection

Passive Infrared device (PIR) can be located within the Immobility Sensor device.

Passive Infrared device (PIR) or movement alarm beams can be positioned around the property of the user.

Mobility activity indicators can be on the person of the system user.

The Immobility Sensor can record the time, date and identity of the mobility detection device.

All mobility and or activity notifiers can communicate with the Immobility Sensor device, using Internet, Telecommunications, hardwire, or radio communication systems.

The Alarm Process

Immobility Sensor will commence the alarm status when hours/minutes to next alarm period has expired. Entering alarm stages/states 1 and 2.

The Immobility Monitor is designed to communicate an alarm event to remote individuals using any of the following: hardwire connection, Internet, telecommunications or radio communication systems.

Setting up the Device

The Immobility Sensor device is able to capture and record the time, date and location of normal activities over a nominated period of time. This historic data can be used to assist the user in establishing the best time sequences to use when setting up the device.

This captured data can be analysed to provide a template for optimum alarm time settings. These optimum alarm timetable settings can then be entered on the device as the user default hours to alarm settings.

Historic Activity Reports Extraction & Exporting

The Immobility Sensor device will capture over 6 months of activity incidents, for example. These incidents are stored with time, date, device location and identity.

From this data a series of daily/weekly activity reports will be generated. These reports will be compiled into a compilation report to allow extraction of any unusual activity behaviour.

The captured activity data can be exported from the monitoring device by transmission of the data using Internet, telecommunications, hardwire, or radio communication systems.

The captured activity data can also be exported from the monitoring device by inserting a removable memory device directly into the monitoring device. Upon detection of this removable memory device, all stored activity records will be automatically downloaded onto the removable device.

Automatic System configuration

Configure and or amend within the monitoring systems memory, the immobility duration periods, contacts information, and recorded messages by utilising a memory device. When plugged directly into the device this new information will automatically upload new files from the memory device, when the memory device is detected.

Amendments to the optimum alarm timetable can be uploaded from a remote location by using Internet, telecommunications or radio communication systems.

Manual System Configuration

Enter and amend the contact details for the list of nominated careers via the system keypad.

Enter recorded messages via the system microphone and keypad

Enter and Amend the Immobility Sensor Optimum alarm timetables via the Immobility Sensor operating keypad.

Prime System Functions

When the Monitoring system is operational, its prime purpose is to attempt to countdown hours and minutes to reach zero. When the device reaches zero it will automatically enter into its alarm state (see alarm stages 1 and 2). Once it enters this alarm state, its prime function is to summon assistance.

The Monitoring system will stop reaching zero and going into an alarm state by receiving a movement detection signal from a movement detection device or via a manual intervention signal.

This movement detection/intervention signal will cause the countdown sequence to stop and restart again. The device will then allocate the next time alarm from the optimum alarm timetable programmed in the device software. See example table FIG. 1.

The device is designed to capture, record and report multiple activity signals. The monitoring device will record the time, date, identity/location of each activity signal device.

The monitoring device will at regular intervals compile a report from the collected movement data. This report will then be sent to one or more nominated locations utilising Internet, telecommunications or radio communication systems. These reports are designed to provide an historical report of activities, highlighting unusual activity patterns.

### How Immobility Monitor Works

Immobility Sensor is a monitoring device, designed to call, for assistance when it detects a prolonged period of inactivity.

When the Monitoring system is activated, the unit will start a countdown sequence as per the time of day hours/minutes remaining to alarm activation; see FIG. 1.

When the Immobility Sensor ends a countdown period, the alarm system will be activated. The alarm system comprises of two alarm stages/states, Alarm stage 1 and 2.

The Alarm Stages 1 and 2

This invention will automatically enter alarm stage 1 when it detects a prolonged period of inactivity.

When an alarm stage 2 is activated, the Immobility Sensor System will automatically initiate and communicate an emergency message to a nominated series of individuals, requesting assistance utilizing Internet, telecommunications, or radio communication technologies

When switched on, the Immobility Sensor will utilise the on board clock and calendar to select the current inactivity period (see FIG. 1). If at the end of any allotted pre-programmed inactivity period no activity has been detected, the device will automatically enter alarm stage 1.

Alarm Stage 1

The function of alarm state 1 is to establish that the unit user is not able to indicate to or move to the immobility sensor device to indicate their wellbeing by depressing a wellbeing button. If at the end of the allotted stage 1 alarm period no activity is detected by the device, the Immobility Monitor will commence alarm stage 2.

Alarm state 1 only remains active for a short time. Alarm stage 1 causes the Immobility Monitor to communicate a loud audible alarm message to the system user, advising them that no movement has been detection during the current immobility period. The unit then requests a manual intervention from the system user.

If the user provides this manual intervention as proof of wellbeing before it enters alarm stage 2, it will immediately reset the immobility alarm period again and will not enter alarm state 2 mode.

If no intervention is received within a pre-programmed short period of time, the device will enter alarm stage 2.

Option 1

If alarm stage 1 fails to attract manual intervention, the Immobility Monitor will automatically send message to nominated careers and to a 3^{rd} party tracking device.

This message will activate an automatic response from the 3^{rd} party tracking device, causing it to broadcast its current location coordinates. The coordinates will be sent via the 3^{rd} party tracking device to the nominated person.

Alarm Stage 2

When alarm stage 2 has been activated, the device will access the on board database list of nominated individuals/devices. The Immobility Sensor will then broadcast a request for assistance to each database entry in turn. When connected, the Immobility Sensor will communicate the appropriate alarm event message utilising Internet, telecommunications or radio communication systems. It will continue to call all individuals/devices on the list until it receives an acknowledgment from the external source to indicate that assistance will be rendered.

When in immobility monitoring mode, if the Immobility sensor detects activity, the countdown sequence will be automatically stopped, and a new countdown period will restart. This new reset period will be determined by the current time and date of each reset event. See example table algorithm in FIG. 1. This table in FIG. 1 is an example of the setting only. This table if necessary will be individually configured for each user.

Each alarm period of an individual's immobility can be programmed with event periods ranging from minutes through to 72 hours in duration.

Software

The software has been designed and programmed to monitor for prolonged inactivity periods. It will enter an alarm state when any one of the many and differing programmed period of inactivity time has elapsed.

Mobility Detection Devices

Event and activity detection devices in the form of emergency alert button, motion, movement or activity sensors, which can communicate with the main monitoring system, using any or all of the following communication protocols: radio communication technology, wireless radio communication, Internet communication technology or communication using hard wire connection. These devices are located/installed on the or near the person or around the property of the user. The purpose of the monitoring devices is to detect and report back to the monitoring system, the activity/movement of the system user.

Immobility Sensor

A receiver device (Immobility Sensor System control unit) located locally or at a remote location. This device will receive signals from the manual intervention devices, motion, movement or sensor transmission devices using Internet based protocols, mobile or hardwired telecommunications technologies or radio communication systems.

The Immobility Sensor will receive signals from one or more of the following devices: an emergency alert button; a motion/movement sensor; or an activity sensor device. These devices are located on or near the person of the user or property of the user.

When a signal is received from any one of these devices, the immobility Sensor device will stop the minutes or hours and minutes remaining to alarm.

If the signal is from an emergency alert device, the unit will immediately enter alarm stage 2 and call for immediate assistance.

If the signal is transmitted from an immobility or movement detection device, the receiver device will initiate a new minutes and or hours and minutes countdown to alarm period as per the table in FIG. 1.

Immobility Detection Periods

Each hour of each day can be programmed with multiple and differing immobility periods.

The immobility periods set for each hour of each day of the week can vary.

The immobility periods set for each hour of each day of each month can vary.

Each immobility period can vary in duration from 1 second to 72 hours.

### The Equipment

The Immobility Monitoring system is made up of a number of components. The novel component for this invention is the Immobility Sensor software logic, and hardware designed and manufactured by Seniors Wellbeing Ltd. The device interfaces with external detection/monitoring devices, which are designed to detect, and report of localised movement or activity. They can communicate these activities utilising hardwire connection, Internet, telecommunications or radio communication systems. The software logic will utilise a unique logic set to assign a unique immobility period to each hour of each day, week or month.

The system may be integrated with another device such as a controller unit which comprises a communication interface. Additional features or functions on the controller may include a USB port, a receiver, and auxiliary speakers.

The Immobility Sensor system may comprise the following components:
1. Movement sensor/transmission device/devices which is/are located on the person of the homeowner and/or around the home where it/they will have the ability to detect movement around the home. Their purpose is to detect activity/movement of the owner in and around the home, and communicate this detection to the main immobility Sensor unit.
2. Ambient temperature monitoring and transmission equipment is located in or around the home of the user.
3. The main Immobility. Sensor unit can be located in the home of the user. Or it can be remotely located. If it is located in the home of the user, it will require connection to power and connection to an external telecommunications network, and/or have access to the internet network.
4. If the main immobility monitor timing device is located at a remote location, it will receive each activity and or immobility, movement and alarm notifications either by the use of telecommunication technology, internet technology, hardwired communication, radio or via satellite connectivity.
5. The immobility monitor has been designed to receive signals from sensor devices located on, near or around the home of the user. These signals will stop the hours to alarm period in the immobility monitor and restart new hours to alarm period as per the table in FIG. 1.
6. The receiver device and or the motion detection device will record and store movement and or triggered events, their locations, times and dates.
7. An Immobility Sensor device with a programmable 24 hour 7 day timer with the ability to be set variable seconds, minutes or hours to alarm activation periods'in any of the hours in the 7 day period. Any one alarm activation period can range from 1 second to 72 hours.
8. A communication device, which can store the contact details for at least 6 different locations.
9. When alarm state two is entered, the on board communication device will in sequence attempt to communicate in turn with the locations listed/stored in the communication device and deliver the details of the location and the necessary information about the monitored individual and the exact nature of that particular alarm event.
10. A communication device that can distinguish 6 different alarm event types.
11. The immobility monitoring device has the ability to receive and understand an acknowledgment signal from the message recipient, to indicate that the message has been successfully received by an appropriate agent who indicates by sending a signal back to the device to indicate that they will action this message. If this receipt acknowledgment signal is not received, the Immobility Sensor communication device will disconnect from the current communication and will move on to the next contact record in the database of parties to be contacted. When the correct response is received, the communication device will stop the emergency call out routine.
12. A communication device which has the ability to store in excess of 10 recorded messages. These messages can be used to deliver a message relating to the exact nature of the alarm event. I.e. inactivity, fire, intruder, ambient temperature alert, panic button, return system to home mode etc.
13. A communication device which has the ability to transmit the appropriate recorded message, based on the nature of the incoming alarm mode, i.e. inactivity, fire, intruder, ambient temperature alert, panic button, return system to home mode etc.
14. A mobile, remote transmission device with an emergency button which has the ability to transmit to the Immobility Monitor an emergency signal to cause the unit to engage immediate alarm mode (stage two).
15. A device with a home or away indicator, so that when the home owner leaves the property, they will turn the Immobility Monitor to away status. This will convert the monitor into a domestic intruder alarm system. If movement is detected whilst in this mode it will communicate an intruder detection message by using the appropriate contact individual details in the database of event contacts.
16. When the home owner returns, they will turn the Immobility Monitor home mode. This will return the monitor to its primary immobility monitoring function.
17. A device that will alert the user to return the Immobility Sensor to primary function if they forget to do so.

### Installation

The Immobility Sensor unit base unit will be installed in a convenient location around the home, close to power and communication sources, and is able to allow the home owner to interact with the unit.

The immobility Sensor unit can be installed remotely and receive activity alerts as described above.

The remote activity sensor units will be on or near the person of the home owner or in one or multiple positions around the home.

Option. A personal activity sensor unit will be on the person of the system user.

Option. A panic emergency button will be on the person of the home owner.

Option. A panic emergency button will be in the home or on the surface of the immobility monitor.

A cancel alarm button will be in the home or on the surface of the immobility Sensor.

A system programming uploading and downloading port will be in the home of the user to allow automatic configuration setup of the device.

Programming, uploading and downloading of the Monitoring System can be carried out using a remote internet connection.

Programming buttons and a display will be on the surface of the immobility Sensor to aid system configuration

The unit may operate using 110v-240v power supply. The unit may operate using 12v power supply.

The unit can utilize access to a dedicated or non dedicated telephone line; or the system can utilize mobile telecommunications technology;

or

the system can utilize internet based communications technologies;

or

the system can utilize satellite communications technologies.

### Immobility Alarm Sequence

An alarm event will result when the minutes and or hours to activation period has reached zero. This will force the Immobility Monitor to commence local alarm mode stage one.

Stage One

The local alarm mode process will activate a localised audible alarm/message which will request the owner to indicate that they are well by cancelling the impending alarm process. If no interaction is received, the alarm sequence (stage two) will commence 60 seconds after stage one alarm mode has commenced.

Stage Two

Alarm mode stage two will commence 60 seconds after stage one has commenced, unless stage one is cancelled by the system user. The immobility Sensor will commence communicating with the first contact on the contact list. When the connection to the first contact has been successfully been established, the appropriate audio message will be delivered, stating that a situation has occurred, the owners details will be transmitted. A request for message receipt/message understanding and a message response communication will be requested by the device. This response can be generated by the message recipient by depressing a button on their communication device. If the requested return signal is not received within a defined period, the unit will disconnect from the first contact and commence contacting the next contact on the list. This will continue up to 10 times or until the correct response has been received.

Once the correct signal/response has been received, the unit will enter standby mode.

FIG. 1 illustrates the recording of a Schedule as an embodiment of the present invention.

The times below can be factory default. The reset hours/minutes to reset can vary from user to user. The hours/minutes to activation can be set from 1 second, up to 72 hours with 7 day variable or same option.

### Immobility Monitor Features

On/off switch
Home and away buttons (unit enters intruder alarm mode when turned off)
Retains all information when power is lost
Inbuilt real time Clock
Inbuilt full Calendar
Automatic leap year adjustment
Visual time and day clock
Removable media technology
Automatic software update using plug in media technology
Activity event audit trail
Visual activity events on system display
Alarm event audit trail
On board microphone
On board speakers
60 second voice alert prior to transmitting alarm
Multiple recorded messages storage areas
Emergency pendent with Activate and cancel button (Optional)
Ambient room temperature monitor too cold/too hot
Onboard help & cancel buttons
Backlit Help & Cancel button
Local & remote programming/control using on board key pad and removable technology
Large backlit, high intensity LCD Display for full visual description of events and programming options
Storage area for phone numbers/contact information
Respond to both DTMF and GSM incoming signals
Programmable voice annunciation
Heavy duty rechargeable battery with inbuilt battery testing capabilities
Inactivity timed monitoring function (FIG. 1)
Wired, wireless Devices and ip address devices (Pet Proof PIRs, Fire, alarm call pendant, spare.
Automatic system tests, power fail and low battery alarm
Automatic telephone line failure alarm
Onboard programmable cancel button
In-built range test function with full audio and visual verification
Automatic busy ring detect
Waterproof pendants (Interchangeable for around the neck, wrist or wall mounted).

Communication Devices

1. A communication device is an interface which can in sequence communicate with the locations, contacts, devices listed/stored in the Immobility sensor device. It will communicate utilising any of the following protocols: Internet, mobile and hardwired telecommunications protocols or radio/terrestrial communication systems.

2. The communication device can call all 10 locations in sequence. It will cease to call locations when it has delivered its call for assistance message and has received an acknowledgment of receipt message.

3. The communication device that will call all 10 locations in sequence 1 to 10 and will continue sequence 10 further times until it receives an acknowledgment of receipt.

4. The communication device with the ability to store in excess of 10 recorded messages or commands.

5. The communication device with the ability to communicate the appropriate message, or command, based on the nature of the alarm event.

6. The communication device that can communicate status of the system and activity reports to external resources.

The system or device comprises the following additional features:

7. A mobile alarm button device, which can be worn on the person of the user, or placed near the user. This device will have the ability to communicate with the Immobility Monitor, utilising Internet, telecommunications or radio communication systems. The signal from this device will activate the Immobility Sensor unit into immediate alarm mode stage two.

8. A device that will automatically instruct the owner to turn the device to immobility

Sensor mode when they return to the property. This will return the monitor to its primary function.

9. A device that will warn of intruders when the system user is away and the immobility monitor's Away button is turned on.

10. A device that can distinguish the identity of different alarm devices, such as Fire detection device, Gas detection device, Movement detection/sensor device identification.

11. A device that will alarm if the ambient temperature reaches pre programmed extremes.

While considerable emphasis has been placed herein on the specific features of the preferred embodiment, it will be appreciated that many additional features can be added and that many changes can be made in the preferred embodiment without departing from the principles of the invention. These and other changes in the preferred embodiment of the invention will be apparent to those skilled in the is art from the disclosure herein, whereby it is to be distinctly understood that the foregoing descriptive matter is to be interpreted merely as illustrative of the invention and not as a limitation.

1. A system for monitoring immobility of a person or user comprising one or a series of sensors or monitors and one or a series of programmable timers, and compatible software to enable programming of a plurality of timers monitoring from minute to minute, or day to day, or week to week, or month to month, or on an yearly basis wherein one of the said timers is set to be loaded at one hour intervals to correspond to a multiple of unique predetermined hourly settings to detect activity of the person or user.

2. The system according to claim 1 wherein the timer loads its settings corresponding to a predetermined setting for that hour, and if no activity is detected during the active hour, this setting is not implemented.

3. The system according to claim 1 wherein the timer defaults its settings corresponding to a predetermined setting to an active hour, and if activity is detected during the active hour, this setting is implemented.

4. The system according to claim 1 wherein the system functions as an intruder alarm.

5. The system according to claim 1 wherein the sensors and/or monitors are programmed to record daily activities of a person to produce the data obtained from the record which is used to formulate a behavioral pattern for the individual person.

6. The system according to claim 1 wherein the system is compatible for use with a Wi-Fi, Bluetooth, ZigBee or similar

7. The system according to claim 1 wherein the system activates an emergency each time a daily recorded inactivity period has been detected.

8. The system according to claim 7 wherein contact personnel is alerted as a result of the depressing of a remote emergency button in the event of an emergency.

9. (canceled)

10. The system according to claim 1 wherein the system monitors and calls for assistance if the ambient temperature reaches and records below or above the pre set parameters.

11. The system according to claim 1 further comprising a battery standby system installed to provide full operational capabilities for up to 24 hours, independent of any external power source.

12. A method for monitoring the immobility of a person or user comprising the steps of:
(i) providing a system comprising an immobility sensor, an immobility detection device, mobility activity indicators, mobility notifier, a controller unit, a timer or a series of programmable timers and compatible software and hardware, one of the said timers is set to be loaded at one hour intervals to correspond to a multiple of unique predetermined hourly settings;
(ii) loading a timer setting corresponding to a predetermined setting for that hour, and if no activity is detected during the active hour, this setting is not implemented; or
(iii) loading a default timer setting corresponding to a predetermined setting to an active hour, and if activity is detected during the active hour, this setting is implemented; and
(iv) activating an alarm by two phases, Stage 1 and Stage 2;
(v) detecting a predetermined period of inactivity by an Immobility sensor thereby activating Stage 1 alarm;
(vi) broadcasting a Stage 1 alarm message via an on-board audio recorder/player and internal and external speakers to the user, requesting the user to respond to a recorded message, upon activation of the Stage 1 alarm;
(vii) playing of a recorded message via the speaker/s to the user via an audio player, requesting the user to depress a cancel alarm button; upon activation of the alarm; and
(viii) activating the Stage 2 alarm if the user fails to intervene or respond to the Stage 1 alarm.

13. The method according to claim 12 wherein if the user fails to intervene or respond to Stage 1 alarm, and the Stage 2 alarm is activated, an automatic emergency alert message is sent to an emergency contact or contacts.

14. The system according to claim 1 further comprising a Stage 1 alarm and a Stage 2 alarm, and an emergency alert button.

15. The system according to claim 14 wherein the button is worn by the user or placed near the user.

16. The system according to claim 14 wherein if the user fails to intervene or respond to the Stage 1 alarm, and the Stage 2 alarm is activated, an automatic emergency alert message is sent to an emergency contact or contacts.

17. The system according to claim 1 wherein the sensors or monitors are programmed to record all daily activities of all persons in a home, to produce activity reports.

18. The system according to claim 17 wherein data from the daily activity report is used to formulate a behavioral pattern for the individual person or user.

19. The system according to claim 18 wherein the activity report can be used to generate an actual and/or average week report in the life of the user.

20. (canceled)

21. A method of monitoring immobility of a person or user comprising:
(a) activating a sensor which detects a period of activity;
(b) detecting and recording a period of activity based on a timer or a series of programmable timers and compatible software and hardware, one of the timers is set to be loaded at one hour intervals to correspond to a multiple of unique predetermined hourly settings;
(c) activating an alarm set by two phases, Stage 1 and Stage 2;
(d) loading a timer setting corresponding to a predetermined setting for that hour, and if no activity is detected during the active hour, this setting is not implemented; or
(e) loading a default timer setting corresponding to a predetermined setting to an active hour, and if activity is detected during the active hour, this setting is implemented; and
(f) detecting a predetermined period of inactivity by an Immobility sensor thereby activating Stage 1 alarm;
(g) broadcasting a Stage 1 alarm message via an on-board audio recorder/player and internal and external speakers to the user, requesting the user to respond to a recorded message, upon activation of the Stage 1 alarm;
(h) playing of a recorded message, upon activation of the alarm, via the speaker/s to the user via the audio player, requesting the user to depress a cancel alarm button; and
(i) activating the Stage 2 alarm if the user fails to intervene or respond to the Stage 1 alarm.

22. The method according to claim 21 wherein if the user fails to intervene or respond to Stage 1 alarm, and the Stage 2 alarm is activated, an automatic emergency alert message is sent to an emergency contact or contacts.

23-34. (canceled)
